(19) United States
(12) Patent Application Publication
(10) Pub. No.: US 2011/0136003 A1
(43) Pub. Date: Jun. 9, 2011

(54) Rechargeable Battery

(76) Inventors: Yong-Sam Kim, Yongin-si (KR); Kyu-Won Cho, Yongin-si (KR); Soo-Kyoung Yoo, Yongin-si (KR)

(21) Appl. No.: 12/959,328

(22) Filed: Dec. 2, 2010

Related U.S. Application Data
(60) Provisional application No. 61/267,354, filed on Dec. 7, 2009.

(30) Foreign Application Priority Data
May 7, 2010 (KR) 10-2010-0042961

(51) Int. Cl. H01M 2/10; H01M 2/30

(52) U.S. Cl. 429/179; 429/186

(57) ABSTRACT

A rechargeable battery includes a case; an electrode assembly housed in the case and having a first substantially planar surface, a second substantially planar surface and a connecting portion connecting the substantially planar surfaces; and a support plate between the case and the electrode assembly, wherein the support plate is electrically coupled to the electrode assembly and has a substantially planar portion generally adjacent to and overlapping at least one of the substantially planar surfaces.

### CROSS-REFERENCE TO RELATED APPLICATION

This application claims the benefit of U.S. Provisional Application No. 61/267,354, filed on Dec. 7, 2009, in the United States Patent and Trademark Office, and claims priority to Korean Patent Application No. 10-2010-0042961, filed on May 7, 2010, in the Korean Intellectual Property Office, the disclosures of which are incorporated herein in their entirety by reference.

### BACKGROUND

1. Field

This disclosure relates to a rechargeable battery and more particularly to a rechargeable battery including a safety device.

2. Description of the Related Art

A rechargeable battery can be recharged and discharged unlike a primary battery that cannot be recharged. A rechargeable battery with low capacity is often used for a small portable electronic device such as a mobile phone, a laptop computer, and a camcorder, while a rechargeable battery with large capacity is typically used as a power source for driving a motor such as for a hybrid vehicle.

Recently, a large capacity high power rechargeable battery has been developed using a non-aqueous electrolyte with high energy density. The aforementioned rechargeable battery with large capacity is formed into a battery module with large capacity by coupling a plurality of these rechargeable batteries in series or in parallel in order to use them to drive a device, for example, a motor in an electric vehicle requiring a large amount of electric power. The rechargeable battery may be fabricated to have a cylindrical shape, a prismatic shape, and the like.

A prismatic rechargeable battery includes an electrode assembly including positive and negative electrodes and a separator therebetween, a case having a space in which the electrode assembly is located, a cap plate closing and sealing the case, and a terminal electrically connected to the electrode assembly and protruding through the cap plate out of the case.

If the rechargeable battery is pierced by a conductive foreign particle such as a nail, a drill, or the like, a short circuit may occur inside the battery. The short circuit may sharply increase a temperature inside the rechargeable battery and cause danger of a spark or explosion.

The above information disclosed in this Background section is only for enhancement of understanding of the background of the described technology and therefore it may contain information that does not form the prior art that is already known in this country to a person of ordinary skill in the art.

### SUMMARY

An exemplary embodiment of the present invention provides a rechargeable having improved safety.

According to one embodiment of the present invention, a rechargeable battery is provided including a case; an electrode assembly housed in the case and having a first substantially planar surface, a second substantially planar surface and a connecting portion connecting the substantially planar surfaces; and a support plate between the case and the electrode assembly, wherein the support plate is electrically coupled to the electrode assembly and has a substantially planar portion generally adjacent to and overlapping at least one of the substantially planar surfaces.

In one embodiment, an insulating film is between the support plate and the electrode assembly. Additionally, the electrode assembly may include a first electrode, a second electrode and a separator between the first electrode and the second electrode, wherein the first electrode has a coated region coated with an active material and an uncoated region absent the active material and wherein the support plate is electrically coupled to the first electrode at the uncoated region.

In one embodiment, the support plate has an angled surface generally corresponding to an angled region of the first electrode, and an attachment surface generally corresponding to the uncoated region of the first electrode. In one embodiment, the support plate and the first electrode comprise the same material and in another embodiment the second electrode and the case comprise the same material.

In one embodiment, the electrode assembly has a second substantially planar surface and wherein the rechargeable battery further comprises a second support plate between the case and the second substantially planar surface of the electrode assembly wherein the second support plate is electrically coupled to the electrode assembly and has a substantially planar portion generally overlapping the second substantially planar surface. In one embodiment, the support plate does not cover the connecting portion of the electrode assembly.

### BRIEF DESCRIPTION OF THE DRAWINGS

FIG. 1 provides the perspective view of a rechargeable battery according to a first embodiment of the present invention.

FIG. 2 is the cross-sectional view of a rechargeable battery cut along the II-II line in FIG. 1.

FIG. 3 is an exploded perspective view showing an electrode assembly and a metal supporting plate according to the first embodiment of the present invention.

FIG. 4 is the horizontally cross-sectional view of members illustrated in FIG. 3, when combined.

FIG. 5 is a horizontally cross-sectional view showing a metal-supporting plate attached to an electrode assembly according to a second embodiment of the present invention.

### DESCRIPTION OF REFERENCE NUMERALS INDICATING PRIMARY ELEMENTS IN THE DRAWINGS

| | |
|---|---|
| 100: rechargeable battery | 10: electrode assembly |
| 11: positive electrode | 12: negative electrode |
| 11a: positive uncoated region | 12a: negative uncoated region |
| 13: separator | 20: cap assembly |
| 21: positive terminal | 22: negative terminal |
| 21a, 22a: terminal flange | 24: washer |
| 25: gasket | 26: insulating member |
| 27: electrolyte injection opening | 29: nut |
| 30: cap plate | 32: lead member |
| 34: case | 38: sealing cover |
| 39: vent member | 39a: notch |
| 40: metal supporting plate | 41, 61, 71: flat part |
| 42, 62, 63: curving slope part | 43, 63, 73: junction part |
| 45, 65, 75: insulating film | 60: first metal supporting plate |
| 70: second metal supporting plate | |

### DETAILED DESCRIPTION

This disclosure will be described more fully hereinafter with reference to the accompanying drawings, in which exemplary embodiments of this disclosure are shown. As those skilled in the art would realize, the described embodiments may be modified in various ways all without departing from the spirit or scope of this disclosure. In the specification and drawings, like reference numerals designate like elements.

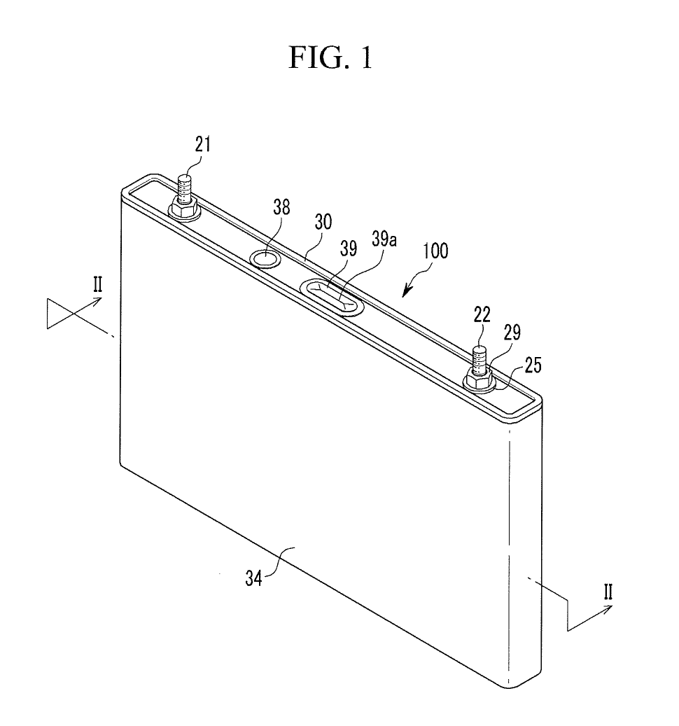

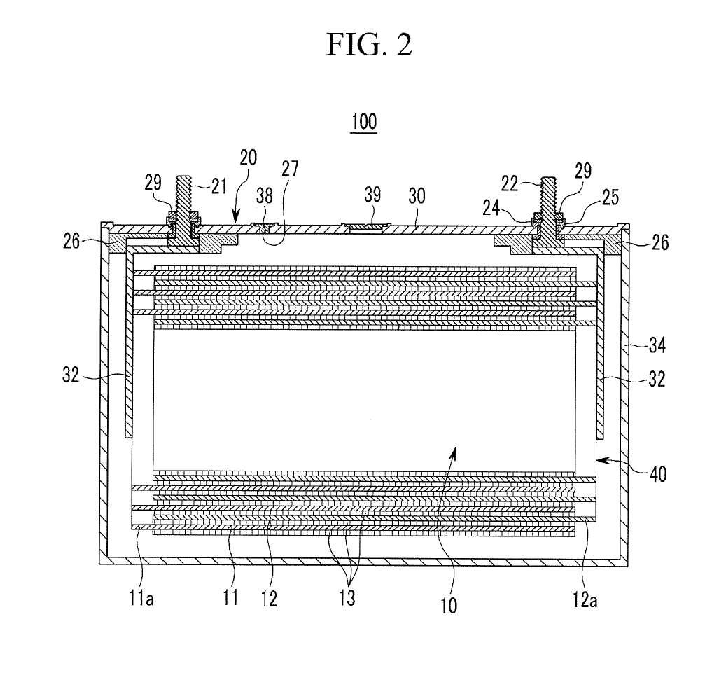

FIG. 1 is the perspective view of a rechargeable battery according to the first embodiment, while FIG. 2 is a cross-sectional view of the rechargeable battery cut along the line II-II.

Referring to FIGS. 1 and 2, a rechargeable battery 100 according to a first embodiment of the present invention includes an electrode assembly 10 fabricated by winding positive and negative electrodes 11 and 12 and a separator 13 located therebetween, a case housing the electrode assembly 10, and a cap assembly 20 combined with the case 34.

According to the first embodiment of the present invention, a rechargeable battery 100 will be illustrated as a prismatic lithium ion secondary battery. However, this disclosure of embodiments of the present invention is not limited thereto, but rather may be applied to various battery types such as a lithium polymer battery, a cylindrical battery, or the like.

The positive and negative electrodes 11 and 12 may include a coating region prepared by coating a current collector made of a thin metal foil plate with an active material and uncoated regions 11a and 12a not coated with the active material.

The positive uncoated region 11a is formed at one end of the positive electrode 11 along the length direction, while the negative uncoated region 12a is formed at the other end of the negative electrode 12 along the length direction. Next, the positive and negative electrodes 11 and 12 and the separator 13 therebetween as an insulator are spiral-wound. In addition, the electrode assembly 10 may be supported outside by a finishing tape to support the shape.

However, this disclosure is not limited thereto but may include the electrode assembly 10 prepared by laminating a plurality of positive and negative electrodes and a separator therebetween.

The case 34 has a generally cuboid shape and an opening at one side. The cap assembly 20 includes a cap plate 30 covering the opening of the case 34, a positive terminal 21 protruding from the cap plate 30 and electrically connected to the positive electrode 11, a negative terminal 22 protruding from the cap plate 30 and electrically connected to the negative electrode, and a vent member 39 equipped with a notch 39a that can be fractured depending on a predetermined internal pressure.

The cap plate 30 is made of a thin plate and includes an electrolyte injection opening 27 for implanting an electrolyte solution at one side and a sealing cover 38 for sealing the electrolyte injection opening 27.

Between the cap plate 30 and terminals 21 and 22 is a gasket 25 to electrically insulate the cap plate 30 from the terminals 21 and 22. The terminals 21 and 22 include a positive terminal 21 and a negative terminal 22. The gasket 25 is fit into the terminal hole. In one embodiment, the gasket 25 is made of two pieces and respectively positioned adjacent to top and bottom of the terminal hole.

The terminals 21 and 22 have a generally circular cylinder shape and a screw thread on the external circumference for attachment of a nut. They may further include a washer 24 between the nut 29 and the gasket 25 to buffer their combining strength. Additionally, the terminals 21 and 22 have terminal flanges 21a and 22a at the bottom to support themselves.

Between the terminal flanges 21a and 22a and the cap plate 30 is a lower insulating member 26 for insulation. The terminals 21 and 22 are inserted into the lower insulating member 26. The terminal flanges 21a and 22a are welded with a lead member 32 electrically connected to a positive electrode 11 or negative electrode 12. The terminal flanges 21a and 22a and the lead member 32 are fit into a hole formed at the bottom of the lower insulating member 26.

In addition, a metal supporting plate 40 is welded into the negative uncoated region 12a to externally support the electrode assembly 10.

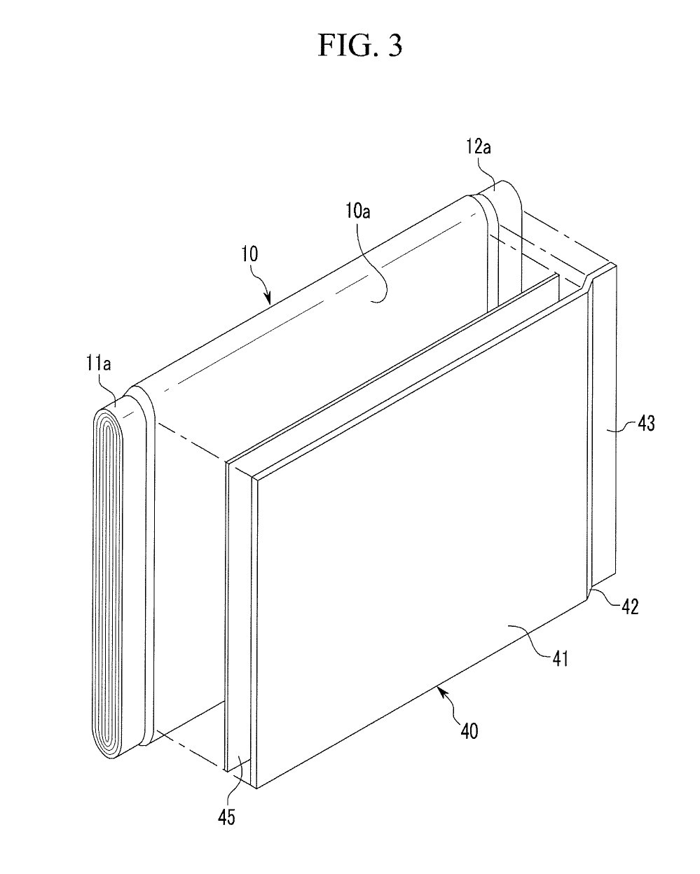

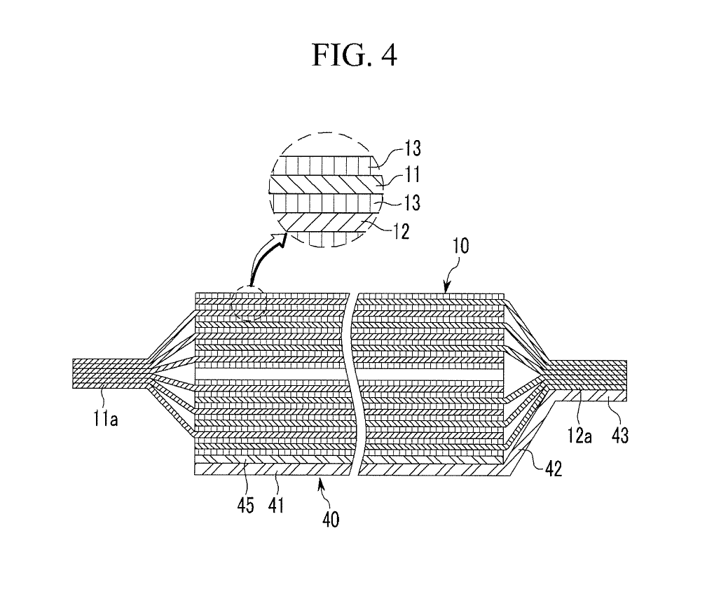

FIG. 3 is an exploded perspective view of an electrode assembly and a metal supporting plate according to the first embodiment of the present invention. FIG. 4 is a horizontally cross-sectional view of the above members shown in FIG. 3 when combined.

Referring to FIGS. 3 and 4, the metal supporting plate 40 according to the first embodiment of the present invention includes a flat part or substantially planar portion 41 facing the front side of the electrode assembly 10, a curving slope part or angled region 42 formed at one end of the flat part 41 and curved or angled toward an electrode assembly, and a junction part or attachment surface 43 formed at the end of the curving slope part 42 and electrically connected to the negative uncoated region 12a.

The metal supporting plate 40 is welded with the negative uncoated region 12a at the junction part 43 and is made of the same material as the negative uncoated region 12a. According to an embodiment of the present, the metal supporting plate 40 is made of copper or a copper alloy.

An insulating film 45 is located between the flat part 41 and the electrode assembly. The insulating film 45 is attached to the flat part 41 and, by being made of a polymer material that does not react with an electrolyte solution, it prevents the electrode assembly 10 from being electrically connected to the flat part 41.

Since uncoated regions 11a and 12a of the electrode assembly 10 are thinner than the coated regions, they are formed to be tilted at an angle where the uncoated regions 11a and 12a meet coated regions coated with an active material. The uncoated regions 11a and 12a are welded together in order to efficiently withdraw a current accumulated therein with low resistances.

The curving slope part 42 in the metal supporting plate 40 contacts the angled negative uncoated region 12a and supports it. The junction part 43 is adjacent the electrode assembly 10 due to the curving slope part 42 generally following a contour of the electrode assembly and can be easily welded to the negative uncoated region 12a. The junction part 43 is oriented in parallel to the negative uncoated region 12a and welded to the negative uncoated region 12a. Accordingly, it can substantially prevent the negative uncoated region 12a from being shaken or dislodged due to external impact or vibration.

Since the negative uncoated region 12a is welded with a lead member 32, there may be insufficient contact between the negative uncoated region 12a and the lead member 32 if the negative uncoated region 12a is shaken or dislodged due to external impact or vibration. However, when the junction part 43 supports the negative uncoated region 12a as in an embodiment of the present invention, insufficient contact between the uncoated region 12a and the lead member 32 due to external impact, vibration, or the like may be substantially prevented.

When a rechargeable battery 100 is pierced by a conductive foreign particle such as a nail, a drill, or the like, the metal supporting plate 40 may be short-circuited to the positive electrode 11, discharging an accumulated current. In a Comparative Example, a metal supporting plate was attached to a positive uncoated region and tested to see if the positive uncoated region was short-circuited to a negative electrode. As a result of the test, the electrode assembly caught fire due to abrupt heat where the supporting plate electrically connected to a positive electrode contacted the negative electrode. In addition, when a metal supporting plate was not included, as tested, in another Comparative Example, positive and negative electrodes were short-circuited and generated much heat, causing an electrode assembly 10 to catch fire when a rechargeable battery was externally pierced by a nail, a drill, and the like.

However, when a metal supporting plate 40 is connected to a negative electrode 12 according to an embodiment of the present invention and is short-circuited to a positive electrode 11 due to a nail piercing a rechargeable battery 100 inside an electrode assembly 10, a current accumulated inside the electrode assembly 10 may be safely discharged without causing the electrode assembly to catch fire. The positive electrode 11 may be configured to connect electrically to the case 34, and thus the metal supporting plate 40 connected to the negative electrode 12 can be short-circuited to the case 34 connected to the positive electrode 11.

In this way, according to one embodiment of the present invention, a rechargeable battery 100 can improve safety by discharging a current and thus, removing a danger of fire when there is a possibility of an explosion when the battery 100 is externally pierced by a foreign particle.

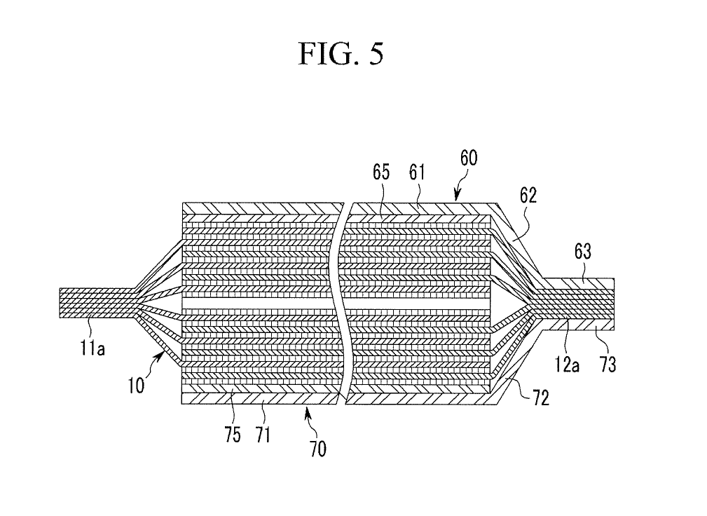

FIG. 5 is a horizontally cross-sectional view of a metal supporting plate attached to an electrode assembly according to a second embodiment of the present invention.

Referring to FIG. 5, a rechargeable battery according to an embodiment of the present invention includes a first metal supporting plate 60 attached to one side of the electrode assembly 10 and a second metal supporting plate 70 attached to the other side thereof.

According to an embodiment of the present invention, the electrode assembly 10 has the same structure as the first embodiment and thus, the description will not be repetitively illustrated here.

The first metal supporting plate 60 includes a flat part 61 facing one side of the electrode assembly 10, a curving or angled slope part 62 connected to one end of the flat part 61 and curved or angled toward the electrode assembly 10, and a junction part 63 protruding from the curving slope part 62. The flat part 61 may have a quadrilateral shape. In one embodiment, an insulating film 65 is located between the flat part 61 and the electrode assembly 10. The insulating film 65 may be made of a polymer material and attached to the flat part 61.

In addition, a second metal supporting plate 70 includes a flat part 71 facing the other side of the electrode assembly 10, a curved or angled slope part 72 connected to one end of the flat part 71 and curved or angled toward the electrode assembly 10, and a junction part 73 protruding from one end of the curved slope part 72. The flat part 71 may have a quadrilateral shape. In one embodiment, an insulating film 75 is located between the flat part 71 and the electrode assembly 10. The insulating film 75 may be made of a polymer material and attached to the flat part 71.

The junction part 63 of the first metal supporting plate 60 and the junction part 73 of the second metal supporting plate 70 are welded to a negative uncoated region 12a and thus, electrically connected to a negative electrode 12.

The first and second metal supporting plates 60 and 70 are made of the same material as a negative electrode current collector and in particular, copper or a copper alloy.

According to an embodiment of the present invention, when the metal supporting plates 60 and 70 are located on both sides of the electrode assembly 10, a rechargeable battery may be safer because a current inside an electrode assembly 10 may be discharged without causing fire or an explosion even when the rechargeable battery is pierced by a drill or a similar implement.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery comprising:
a case;
an electrode assembly housed in the case and having a first substantially planar surface, a second substantially planar surface and a connecting portion connecting the substantially planar surfaces; and
a support plate between the case and the electrode assembly, wherein the support plate is electrically coupled to the electrode assembly and has a substantially planar portion generally adjacent to and overlapping at least one of the substantially planar surfaces.

2. The rechargeable battery of claim 1, further comprising an insulating film between the support plate and the electrode assembly.

3. The rechargeable battery of claim 1, wherein the electrode assembly comprises a first electrode, a second electrode and a separator between the first electrode and the second electrode, wherein the first electrode has a coated region coated with an active material and an uncoated region absent the active material and wherein the support plate is electrically coupled to the first electrode at the uncoated region.

4. The rechargeable battery of claim 3, wherein the support plate is welded to the first electrode.

5. The rechargeable battery of claim 3, wherein the support plate has an angled surface generally corresponding to an angled region of the first electrode, and an attachment surface generally corresponding to the uncoated region of the first electrode.

6. The rechargeable battery of claim 3, wherein the support plate and the first electrode comprise the same material.

7. The rechargeable battery of claim 3, wherein the first electrode and the support plate comprise the same material and the second electrode and the case comprise the same material.

8. The rechargeable battery of claim 3, wherein the case is electrically coupled to the second electrode.

9. The rechargeable battery of claim 1, wherein the support plate comprises metal.

10. The rechargeable battery of claim 9, wherein the metal comprises copper or a copper alloy.

11. The rechargeable battery of claim 1, further comprising a terminal and a lead electrically coupling the electrode assembly to the terminal.

12. The rechargeable battery of claim 1, wherein the electrode assembly has a second substantially planar surface and wherein the rechargeable battery further comprises a second support plate between the case and the second substantially planar surface of the electrode assembly, wherein the second support plate is electrically coupled to the electrode assembly and has a substantially planar portion generally overlapping the second substantially planar surface.

13. The rechargeable battery of claim 1, wherein the support plate does not cover the connecting portion of the electrode assembly.
